(19) United States
(12) Patent Application Publication
(10) Pub. No.: US 2024/0248200 A1
(43) Pub. Date: Jul. 25, 2024

(54) FLY EYE IMAGING RADAR

(71) Applicant: Pavlo A. Molchanov, Las Cruces, NM (US)

(72) Inventor: Pavlo A. Molchanov, Las Cruces, NM (US)

(21) Appl. No.: 18/100,829

(22) Filed: Jan. 24, 2023

(51) Int. Cl. G01S 13/89; G01S 13/44

(52) U.S. Cl. CPC G01S 13/89; G01S 13/4472

(57) ABSTRACT

Fly eye radar is integration of holographic simultaneous wide covering non-scanning system with monopulse high directional accuracy method of multi-beam multi-axis fast signals processing for imaging application. Radar system with multi-beam multi-axis overlap antenna patterns with staring, not scanning continuous wide covering area allow to receive maximum non-interrupting information from multiple objects. Multi-axis 3D object observation provides high-resolution and high probability objects recognition. High-speed object imaging providing by simultaneous multi-channel signals processing with one-step algorithms and reference signals from overlap antennas. Digitizing of reflected signals directly on each directional antenna allows distribution of radar modules around carrier vehicle or swarm of vehicles. Transformation and processing of received signals in time domain, frequency domain and multi-axis space domain provides additional possibility to enhance image resolution and object recognition.

### INTRODUCTION

A human always dreamed about seeing objects through walls, underground, inside body. Diffraction limit, where maximal image resolution determined by wavelength limiting this possibility. High frequency short wavelength radars provide good imaging resolution, but bad penetration, which leads to radar range limitation. Long wavelength radio frequency radars provide good penetration, but low (from tens centimeters to meters) image resolution. As result contemporary underground and through wall radars can show some reflected signals disturbance or brully image of object only.
US 2017/0082732 A2 03/2017 Gordon K. Oswald
US 0,035,783 A1 02/2014 Pavlo A. Molchanov 342/357.59
U.S. Pat. No. 3,906,505 09/1975 Stephen E. Lipsky 343/119

### OTHER PUBLICATIONS

1. Stephen A. Harman “A comparison of staring radars with scanning radars for UAV detection: introduction of the Alarm™ staring radar”, 2015, European Radar Conference (EURAD), EUMA, Sep. 2015, 185-188, XP032824534.
2. Stephen A. Harman, (Aveillant Ltd., Cambridge, U.K.),” Holographic Radar Development“, 2021-02-07 (microwavejournal.com).
3. S. E. Lipsky, “Microwave Passive Direction Finder”, SciTech Publishing Inc. Raleigh, NC 27613, 2004.
4. P. Molchanov, A. Gorwara, “Fly Eye Radar Concept”. IRS2017. International Radar Symposium, Prague, July 2017.

### OBJECT OF THE INVENTION

Object of invention is imaging radar system which provides high resolution imaging, 2-4 orders better than diffraction limit at low radio frequency regime radar range. Image resolution in proposed radar will not limited by reflected signals frequency, but from sampling frequency and transmitted and sampling frequency stability.

### FIELD OF THE INVENTION

It is not image processing technology, it is imaging technology based on application of radio frequency signals for imaging and recognizing small objects (drones) from large distance, imaging hidden/covered underground objects. It is about application of long wavelength radio frequency radar for creating high resolution images. Proposed imaging radar based on processing of reflected from object wavefront signals recorded as digital hologram with non-scanning, non-switching wide all object covering antenna array with reference to processor time. Monopulse processing of antenna signals with overlap antenna patterns provides highest directional resolution. Multi-axis distribution of overlap antennas and application of reference antennas provides maximum information about object shape.

### SUMMARY OF THE INVENTION

Fly eye radar is integration of holographic simultaneous wide covering non-scanning system with monopulse high directional accuracy method of multi-beam multi-axis fast signals processing. Radar system with multi-beam multi-axis overlap antenna patterns with staring, not scanning continuous wide covering area allow to receive maximum non-interrupting information from all object or multiple objects. Multi-axis 3D object observation provides high-resolution and high probability objects recognition. High-speed object imaging providing by simultaneous multi-channel signals processing with one-step algorithms and reference signals from overlap antennas. Digitizing of reflected signals directly on each directional antenna allows distribution of radar modules around carrier vehicle or swarm of vehicles. Transformation and processing of received signals in time domain, frequency domain and multi-axis space domain provides additional possibility to enhance image resolution and object recognition.

### BACKGROUND OF THE INVENTION

Image synthesis using time sequential holography method and apparatus proposed in U.S. Pat. No. 5,384,573, wherein reflections that travel in phase to the observation location; producing two coherent radiation beams, directing the two beams onto a receiving plane provided with an array of radiation receiving cells and storing output signals from each receiving cell, and controlling the two beams. Instead of two beams radar analog of the optical hologram (U.S. Pat. No. 5,734,347) recording a radar image in the range/doppler plane, the range/azimuth plane, and/or the range/elevation plane. The invention embodies a means of modifying the range doppler data matrix by scaling, weighing, filtering, rotating, tilting, or otherwise modifying the matrix to produce some desired result.

But scanning beams with sequential recording of signals do not receiving signals reflected from all objects as in real optical holograms Losing of some parts of signals do not allows to recreate good resolution of object's image.

S. Harman in his paper “A comparison of staring radars with scanning radars for UAV detection” [2] proposed staring radars having multiple static receiver beams that do not scan and are constantly sensing. The fundamental difference between staring and scanning radars is that for a staring radar the transmit beam is stationary and fully filled with potentially multiple static receiver beams. The number of receiver beams within the transmit floodlight determines the gain on receive and the ability to localize in angle. The key opportunity that staring radars offer is the ability to give exceptional information and utility e.g., optimal detection, tracking and target ID capability in an optimal time. This is due to the ability to set the processing dwell time for a given task or alternatively work using multiple parallel processes each having different processing dwell times. Clearly this technique is unachievable in mechanically scanned surveillance radars or conventional phased array radars that can only afford to schedule short periods of time to a given sector in order to maintain complete coverage with acceptable latency.

To reach maximal accuracy of direction finding Lipsky S.E. [3] proposed an antenna array with a plurality of fixed, narrow beamwidth antennas, geographically oriented to provide omnidirectional coverage, a set of antennas is selected. It presents an explanation of the monopulse method for microwave direction finding with two pairs of directional antennas, positioned by Azimuth and Elevation boresight. The general theory of the monopulse method considers that the angle sensing function falls into one of three categories: amplitude, phase, or a combination developed by combining their sum and difference (Σ−Δ).

The phase angle difference, as measured in each antenna, compared against the arriving signal phase front, is denoted as ψ. The difference in signal path length is defined by the equation, S=D sin φ, which depends on the antenna aperture displacement (spatial angular shift) D. Letting φ be the phase lag caused by the difference in the time of arrival between two signals gives:

$$ψ = - 2 π \frac{S}{λ} = - 2 π \frac{D sin φ}{λ} , \qquad ( 1 )$$

where:

φ—the angle of arrival measured from bore sight; λ—the wavelength.

If A and B are RF voltages measured at the reference boresight and incident antennas, respectively, then

$$A = M sin ( ω t ) and \qquad ( 2 )$$

$$B = M sin ( ω t + ψ ) = M sin ( ω t - \frac{2 π D}{λ} sin φ ) , , \qquad ( 3 )$$

where M is a common constant defined by signal power. This shows that the angle of arrival φ is contained in the RF argument or phase difference of the two beams for all signals off the boresight axis. Direction finding by way of amplitude comparison methods can provide a root mean square (RMS) accuracy smaller than 2° in 100 ns after a direct wave arrives. High accuracy phase measurements provide high accuracy and fast direction finding. But most important, that monopulse method do not required long time, from millisecond for small amount operations to tens of seconds for FFT (Fast Fourier Transform), computer calculations and can provide critical information about targets position, speed, and identity.

Combination of staring antenna array with high directional accuracy monopulse method and digital processing and synchronization proposed in paper P. Molchanov, A. Gorwara, “Fly Eye Radar Concept” [4].

### PRIOR ART

In the patent “Radio-frequency holography” U.S. Pat. No. 3,887,923 from Jun. 3, 1975, Charles E. Hendrix (PRIOR ART FIG. 1) proposed a passive radio direction finder monitors wavefronts across an aperture, produces a radio-frequency hologram, and numerically reconstructs the hologram. The direction finder consists of an array of antennas to sample the phase of incoming wavefronts, a plurality of mixers separately connected to individual antennas, a phase lock loop or bandpass limiter connected between any individual antenna and an input of each mixer to provide a mixer reference signal, a multi-channel analog to digital converter attached to the output of each mixer, and a digital computer programmed to make fast Fourier transform calculations. In lieu of the plurality of antennas and mixers, a moving probe antenna and single mixer may be used if a sample and hold circuit is added to the phase lock circuit to provide a reference signal.

But application of analog circuits critical to phase shifts in large size beam forming and direction finding means.

Stephen Anthony Harman in his patent U.S. Pat. No. 11,061,114 B2 from Jul. 13, 2021, “Radar system for the detection of drones” and patent U.S. Pat. No. 9,097,793 B2 “System for the detection of incoming munitions” (PRIOR ART FIG. 2) proposed a radar system for the detection of drones, including a transmitter, a receiver and a processor, wherein the processor is arranged to process demodulated return signals in a first process using a Doppler frequency filter, and to store locations of any detections therefrom, and to process the demodulated signals in a second process to look for signal returns indicative of a preliminary target having a rotational element at a location, and should a detection be found in the second process, to then attempt to match a location of the preliminary target with returns from the first process, and to provide a confirmed detection if a location of a detection from the first process matches with the location of a detection from the second process.

System provides good accuracy of multiple targets detection with non-scanning antenna beam that illuminates the entire search space but switching of a few antennas lead to increasing detecting and processing time. Signals not digitizing on each antenna and not processing from each antenna. Simultaneous digitizing and processing of signals from each antenna element will provide faster processing time for radar.

Patent US 2017/0082732 A2, 03/2017,” Radar system and method” proposed by Oswald Gordon, which presented in PRIOR ART FIG. 3. Invention provides an improved radar receiver, and improved methods for operating, calibrating, and fabricating a radar receiver. The receiver comprising: at least one antenna comprising an array of antenna elements; a first processing stage adapted to process radar signals received via each antenna element of said array; and a second processing stage adapted to serve the first processing stage; wherein said first and second processing stages are each arranged substantially parallel to one another, and to said antenna substrate.

Every antenna element in phase array needs to be omnidirectional as minimum in area of beam control. It means, all antenna elements will receive any jamming signal directed from all angles of view. Adaptive algorithm will be possible only, if jamming signal not large enough to saturate all antenna elements simultaneously.

Application of antennas with overlap antenna patterns will allow better direction finding accuracy by application monopulse method of signals processing and signals from reference antennas.

### SUMMARY OF THE INVENTION

Fly eye imaging radar comprising at least one antenna array, means for transmitting radar signals, means for receiving radar signals and means for processing the radar signals. Said antenna array arranged as array of directional antennas covering wide area of observation with staring, not scanning, overlap in as minimum one axis antenna patterns creating antenna sub-arrays in each axis. Means for transmitting radar signals comprising as minimum one phase-locked loop, signal generator and controllable power amplifier connected with transmitting antenna covering whole area or sub-sector of area of observation. Means for receiving radar signals comprising multiple separate receiving channels with signal conditioning circuit including voltage or current limiters, anti-aliasing circuits, Automatic Gain Control (AGC) means, directional coupler with signal detector and analog-to-digital converter.

Each directional antenna covering whole area or sub-sector of area of observation and coupled with separate receiving cannel providing fast continuous parallel processing of signals for receiving maximum information from all covering area simultaneously. Means for processing the radar signals comprising multi-channel processor, image generator, memory for real time recording digital hologram, synchronization means and at least one monopulse processor connected to each antenna sub-array by directional coupler with signal detector for creating monopulse subarrays.

Monopulse subarrays comprising means for one or multi-axis processing of all signals in receiving channels as ratio of amplitudes and/or phase shift of signals for direction finding and one-iteration adapting for clutter suppressing or decrease transferring media influence to receiving chain parameters by phase shift in subarray of neighboring directional antennas with overlap antenna patterns, wherein application of signals from reference antennas providing highest directional accuracy and better clutter/noise and media influence suppression.

Said multi-channel processor comprised means for transform, correct and filter received signals from time domain to frequency domain and space one axis and/or multi-axis domain to increase image resolution and number of parameters for object recognition. Said antenna array, receiving and processing means arranged for receiving additional Doppler shifted and diffracted spectrum components consists of information about moving objects, objects content by spectrum signature and object shape. Said image generator arranged for generating one or multi-axis images in time, frequency, space, or combined domains. Means for transmitting radar signals, means for receiving radar signals and means for processing the radar signals are connected by digital interface arranged as universal serial bus (USB) or microwave and/or fiber optic waveguides to signal processor or wireless.

### BRIEF DESCRIPTION OF DRAWINGS

PRIOR ART FIG. 1 shows known schematic of the radio frequency holographic radar.

PRIOR ART FIG. 2 shows known drone detection multi-beam radar.

PRIOR ART FIG. 3 shows known multi-beam holographic radar.

FIG. 1 shows diagram of ground based multi-beam multi-axis Fly Eye radar.

FIG. 2 shows diagram demonstrating direction finding with Fly Eye radar system.

FIG. 3 shows diagram of high accuracy phase difference measurement using space tilted directional antennas.

FIG. 4 shows airborne multi-beam multi-axis e Fly Eye radar.

FIG. 5 representing example of two-axis distribution directional antennas in Fly Eye radar.

FIG. 6 representing example of three-axis distribution directional antennas in Fly Eye radar.

FIG. 7 shows diagram of planar holographic monopulse antenna array.

FIG. 8 representing diagram demonstrating recording of digital hologram with non-scanning array of directional antennas.

FIG. 9 shows diagram demonstrating of transferring received and digitized signals from time domain to frequency domain.

FIG. 10 shows block-diagram of first embodiment of Fly Eye radar system.

FIG. 11 shows block-diagram of passive Fly Eye radar with SDR embodiment.

FIG. 12 shows different embodiments of directional antenna arrays.

### DETAILED DESCRIPTION OF THE INVENTION

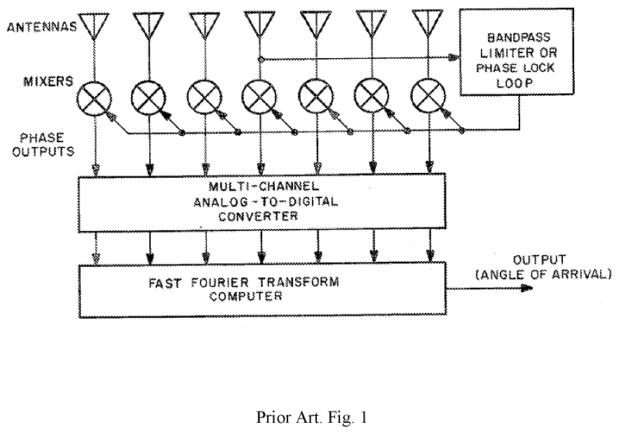

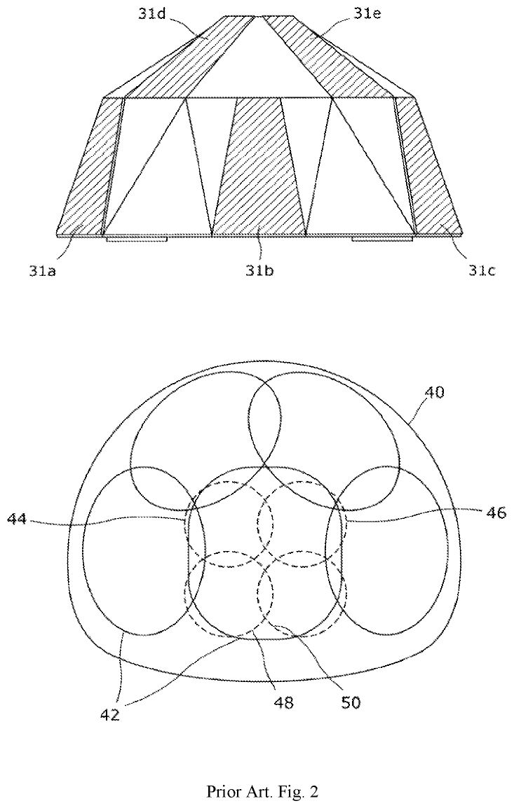

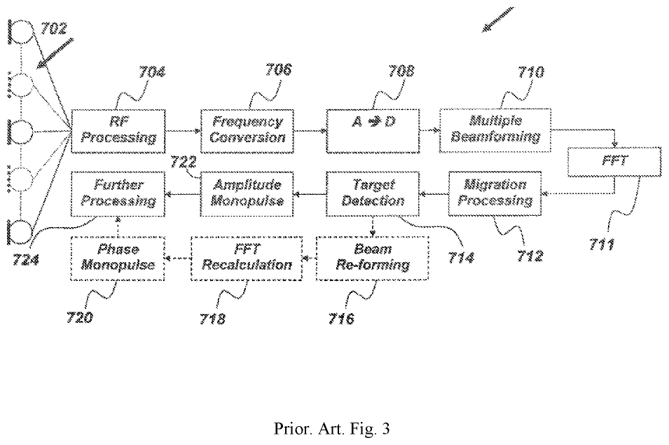

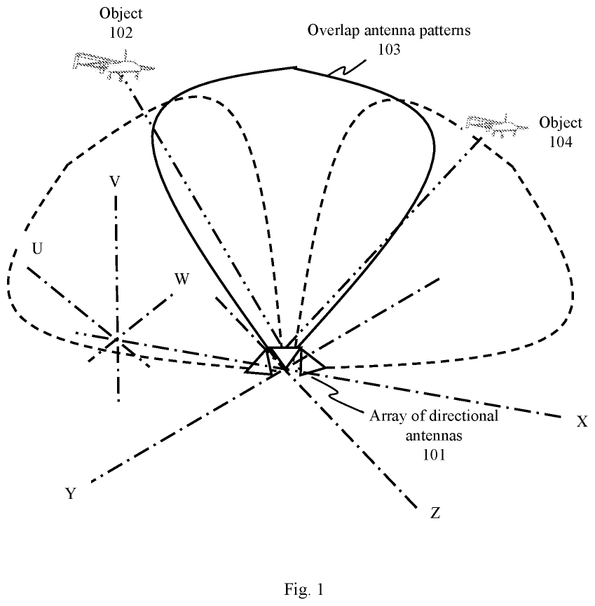

FIG. 1 shows diagram of ground based multi-beam multi-axis Fly Eye radar. Fly eye imaging radar comprising array of directional antennas 101 covering wide area of observation with staring, not scanning directional antennas. Antenna patterns 102 of said directional antennas are overlap in one axis X, as shown in FIG. 1, or can overlap in a few axises Y, Z, U, W creating antenna sub-arrays in each axis for receiving more information from object or targets 103, 104, as shown in FIG. 1.

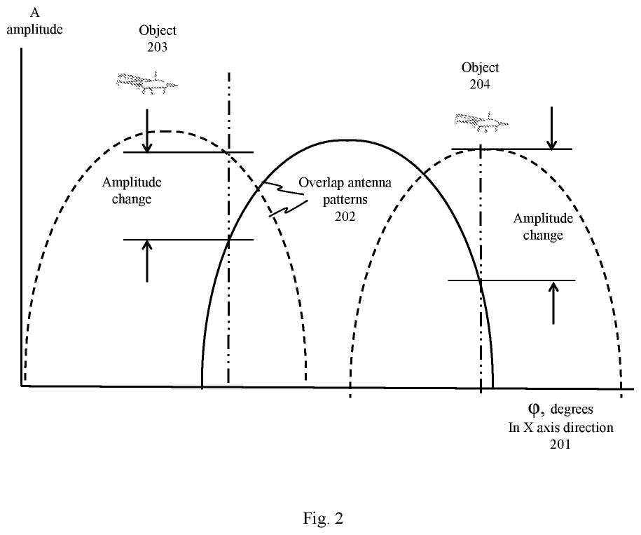

Diagram demonstrating high accuracy direction finding with monopulse antenna system [3] presented in FIG. 2. Direction in polar coordinates 201 can be find as ratio of amplitudes, as show in presented FIG. 2) or phases in overlap antenna patterns 202.

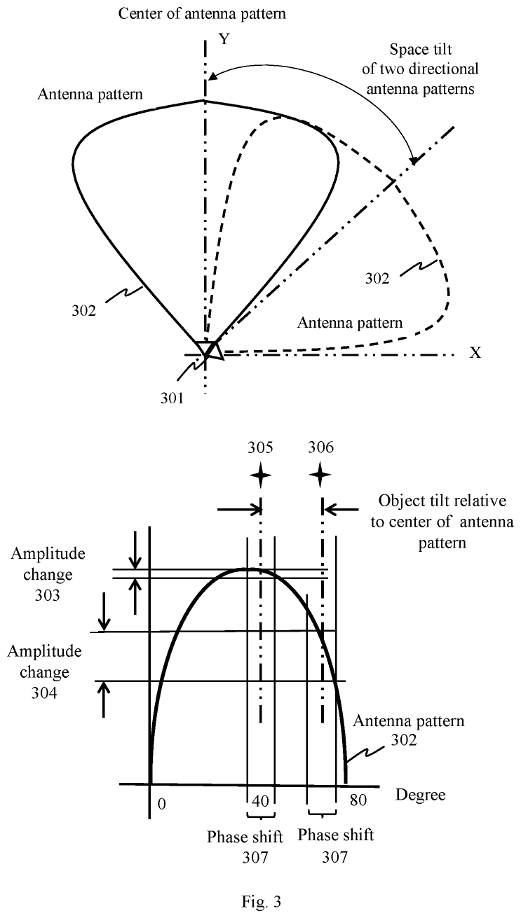

Space tilted directional antennas 301 with overlap antenna patterns 302 provides better directional accuracy than provided by regular measurement. Amplitudes ratio 303 will be larger for tilted antenna, if target will be shifted from center of antenna pattern, position 305 to position 306, which corresponding to same phase shift 307 as shown in diagram in FIG. 3.

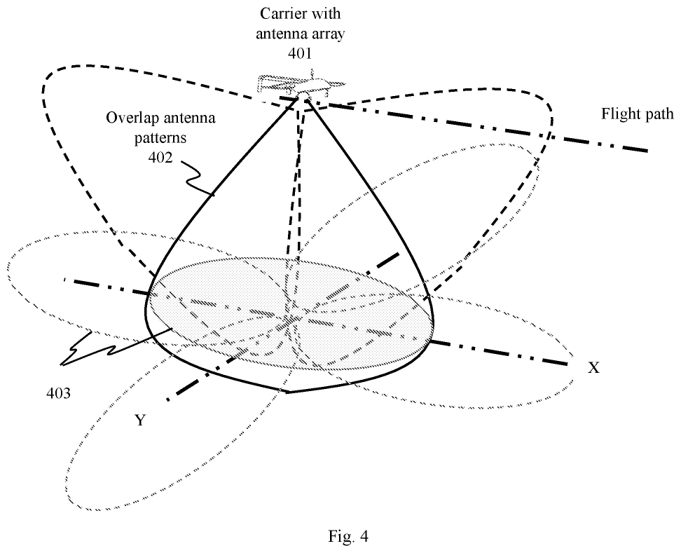

FIG. 4 shows airborne embodiment application of proposed multi-beam multi-axis Fly Eye radar. Directional antenna array 401 positioned on airborne carrier. Overlap antenna patterns 402 illuminating overlap spots on ground 403, which overlap in two axis X, and Y.

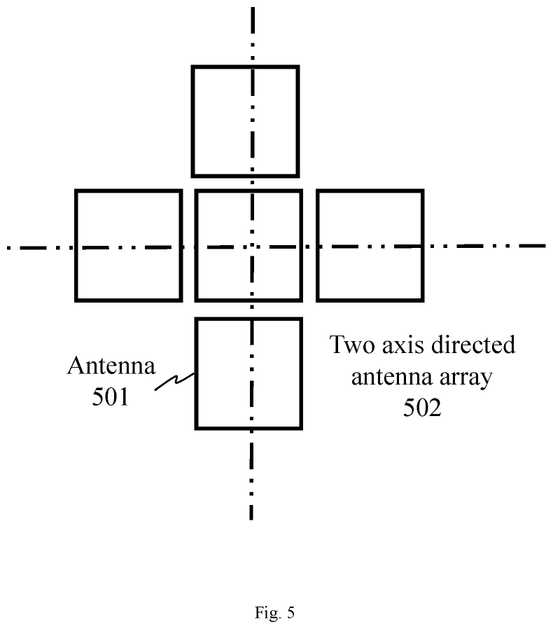

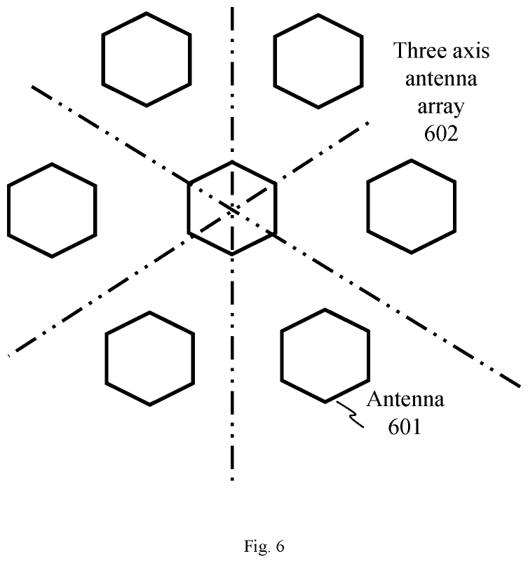

Directional antennas can be distributed in one axis X, two axis 501 and 502, or three axis 601, 602 as shown in FIG. 5, FIG. 6.

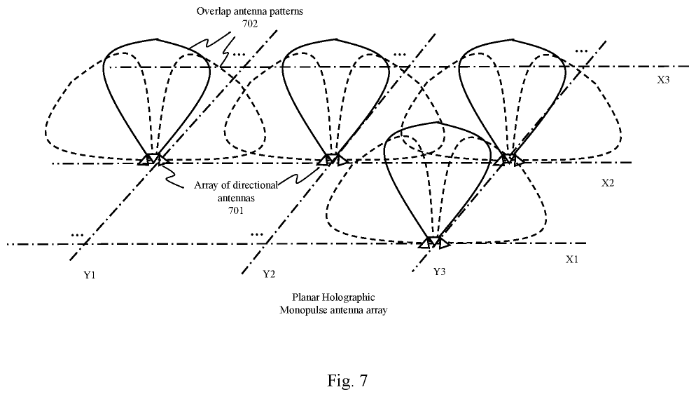

Digital hologram can be recorded by one directional antenna array, as shown in FIG. 1 and FIG. 4, or by multiple directional antennas arrays, as shown in FIG. 7. One recording directional antenna array or multiple antenna array must simultaneously cover all object or area of observation. Scanning antenna systems with narrow beam not covering all object recording only direct reflected signals and are losing signals reflected outside of antenna angle of view. It is main condition for recording real digital holograms. Real optical hologram recording wavefront of signals reflected from all objects (object beam) relative to reference beam. Some existing imaging radar systems are using scanning of narrow beam antennas around object for recording hologram. It can be named quasi holograms. But real digital hologram cannot be recorded by scanning antenna, which not covering all object simultaneously. Losing of signals outside of narrow antenna pattern not compensated by scanning antenna around object surface. As result recovered image losing part of information of object surface and losing resolution. FIG. 7 shows diagram of planar holographic monopulse antenna array, where arrays of directional antennas 701 with overlap antenna patterns 702 are distributed in two axis X and Y.

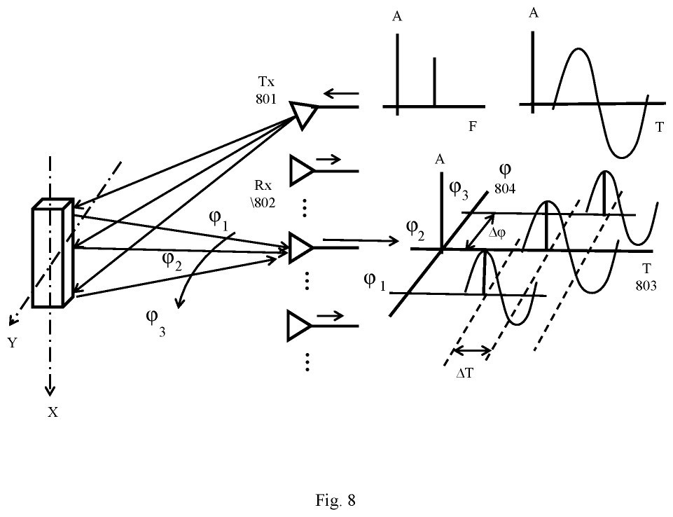

FIG. 8 representing diagram demonstrating recording of digital hologram with non-scanning array of directional antennas. Transmitting signal presented in FIG. 8 is sinusoidal, as normal laser signal, when optical hologram recording. Transmitting antenna 801 need to cover all object simultaneously. Multiple transmitting antennas can be applied in other embodiments for covering all object or entire area of observation. One or multiple receiving antennas 802 need to cover entire object and signals reflected from all objects (wavefront) will be recorded in real time with reference to computer time. Recorded signals have time delay related by distance to object corresponding to different path related object shape, axis T 803 (fast time), and phase delay φ 804 related by different signals ways relative to antenna phase center, axis φ (slow time).

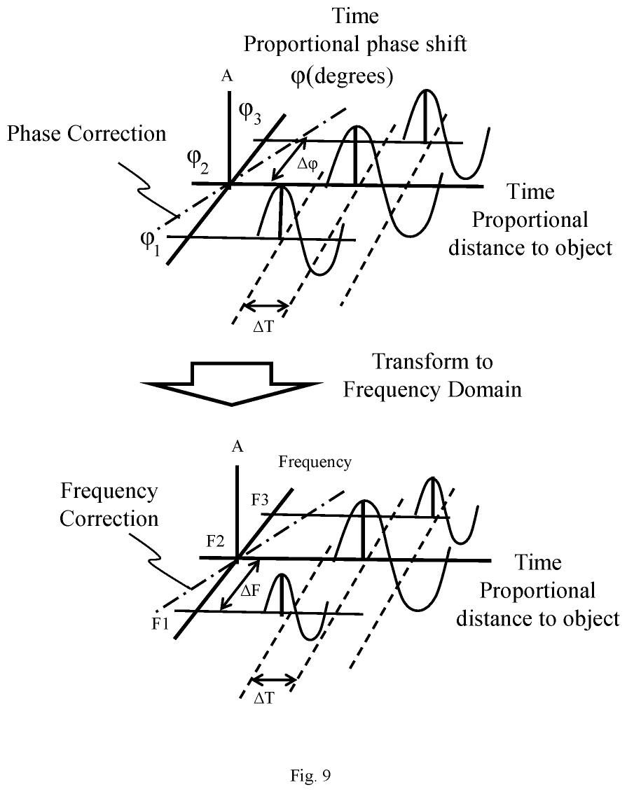

FIG. 9 shows diagram demonstrating of correction and transferring received and digitized signals from time domain to frequency domain. Correction of signals in time domain can be made in frequency domain too.

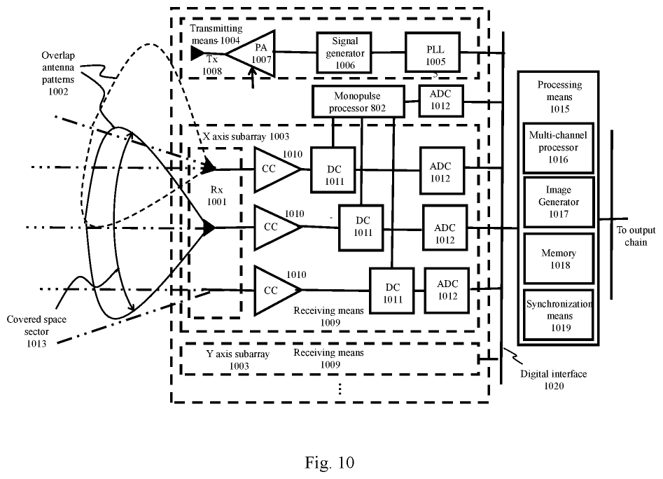

FIG. 10 shows block-diagram of first embodiment of Fly Eye radar system. Array of directional antennas 1001 covering wide area of observation with staring, not scanning, overlap in as minimum one axis antenna patterns 1002 creating antenna sub-arrays 1003 in each axis. Means for transmitting radar signals 1004 comprising as minimum one phase-locked loop 1005, signal generator 1006 and controllable power amplifier 1007 connected with transmitting antenna 1008 covering whole area or sub-sector of area of observation. Means for receiving radar signals 1009 comprising multiple separate receiving channels with signal conditioning circuit 1010 including voltage or current limiters, anti-aliasing circuits, Automatic Gain Control (AGC) means, directional coupler with signal detector 1011 and analog-to-digital converter 1012.

Each directional antenna covering whole area or sub-sector of area of observation 1013 and coupled with separate receiving cannel providing fast continuous parallel processing of signals for receiving maximum information from all covering area simultaneously. Each receiving channel connected to monopulse processor 1014 connected with analog-to-digital converter 1012 and Processing means 1015.

Means for processing the radar signals 1015 comprising multi-channel processor 1016 image generator 1017, memory 1018 for real time recording digital hologram and synchronization means 1019. Subarrays 1003 with monopulse processors 1014 processing of all signals in receiving channels as ratio of amplitudes and/or phase shift of signals for direction finding and one-iteration adapting for clutter suppressing or decrease transferring media influence to receiving chain parameters by phase shift in subarray of neighboring directional antennas with overlap antenna patterns, wherein application of signals from reference antennas providing highest directional accuracy and better clutter/noise and media influence suppression.

Said multi-channel processor 1016 comprised means for transform, correct and filter received signals from time domain to frequency domain and space one axis and/or multi-axis domain to increase image resolution and number of parameters for object recognition. Said antenna array, receiving and processing means arranged for receiving additional Doppler shifted and diffracted spectrum components consists of information about moving objects, objects content by spectrum signature and object shape. Said image generator arranged for generating one or multi-axis images in time, frequency, space, or combined domains. Means for transmitting radar signals 1004, means for receiving radar signals 1009 and means for processing the radar signals 1015 are connected by digital interface 1020 arranged as universal serial bus (USB) or microwave and/or fiber optic waveguides to signal processor or wireless.

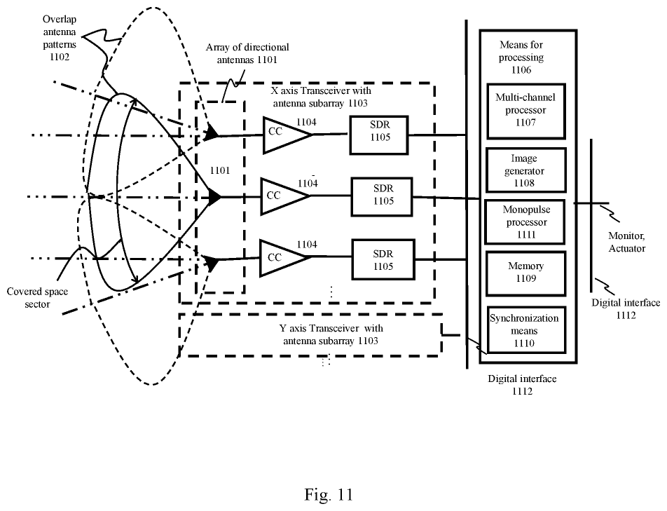

FIG. 11 shows block-diagram of passive Fly Eye radar with SDR. Array of directional antennas 1101 covering wide area of observation with staring, not scanning, overlap in as minimum one axis antenna patterns 1102 creating transceiver with antenna sub-arrays 1103 in each axis. Each transceiver with subarray 1103 comprising multiple separate transmitting and receiving channels with signal conditioning circuit 1104 including voltage or current limiters, anti-aliasing circuits, Automatic Gain Control (AGC) means and connected to Software Defined Radio (SDR) 1105.

Each directional antenna covering whole area or sub-sector of area of observation and coupled with separate transmitting/receiving cannel providing fast continuous parallel detection and tracking of signals for receiving maximum information from all covering area simultaneously. Means for processing the radar signals 1106 comprising multi-cannel processor 1107, image generator 1108, memory 1109 for real time recording digital hologram, synchronization means 1110 and at least one monopulse processor 1111. Monopulse processor 1111 connected to subarrays 1103 comprising means for one or multi-axis processing of all signals in receiving channels as ratio of amplitudes and/or phase shift of signals for direction finding and one-iteration adapting for clutter suppressing or decrease transferring media influence to receiving chain parameters by phase shift in subarray of neighboring directional antennas with overlap antenna patterns, wherein application of signals from reference antennas providing highest directional accuracy and better clutter/noise and media influence suppression.

Said multi-channel processor 1107 comprised means for transform, correct and filter received signals from time domain to frequency domain and space one axis and/or multi-axis domain to increase image resolution and number of parameters for object recognition. Said transceivers with antenna subarray 1103, and means for processing 1106 arranged for receiving additional Doppler shifted and diffracted spectrum components consists of information about moving objects, objects content by spectrum signature and object shape. Said image generator 1108 arranged for generating one or multi-axis images in time, frequency, space, or combined domains. Transceivers with antenna subarray 1103 and means for processing the radar signals 1106 are connected by digital interface 1112 arranged as universal serial bus (USB) or microwave and/or fiber optic waveguides to signal processor or wireless.

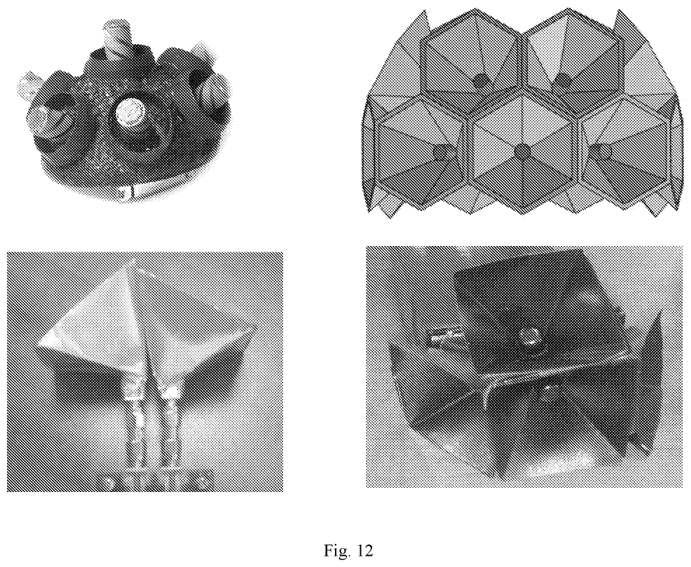

FIG. 12 shows different embodiments of directional antenna array.

### REFERENCE NUMBERS

101—Array of directional antennas
102—Overlap antenna patterns
103—Object
201—Array of directional antennas
202—Overlap antenna patterns
203—Object
204—Object
301—Array of directional antennas
302—Overlap antenna patterns
303—Amplitude change
304—Amplitude change
305—Object shift
306—Object shift for tilted antenna
307—Phase shift
401—Carrier with antenna array
402—Overlap antenna patterns
403—ground spots
501—Antenna
502—Two axis antenna array
601—Antenna
602—Three axis antenna array
701—Array of directional antennas
801—Transmitting antenna
802—Receiving antenna
803—Time axis
804—phase shift axis
1001—Array of directional antenna
1002—Overlap antenna patterns
1003—Subarray
1004—Transmitting means
1005—Phase lock loop
1006—Signal generator
1007—Controlled power amplifier
1008—Transmitting antenna
1009—Receiving means
1010—Conditioning circuit
1011—Directional coupler with detector
1012—Analog-to-digital converter
1013—Covered space sector
1014—Monopulse processor
1015—Means for processing
1016—Multi-channel processor
1017—Image processor
1018—Memory
1019—Synchronization means
1020—Digital interface
1101—Array of directional antenna
1102—Overlap antenna patterns
1103—Transceiver with antenna subarray
1104—Conditioning circuit
1105—Software defined radio
1106—Means for processing
1107—Multi-channel processor
1108—Image generator
1109—Memory
1110—Synchronization means
1111—Monopulse processor
1112—Digital Interface

### Operation

Fly eye imaging radar comprising transmitting and receiving of electromagnetic signals means provided by one directional antenna or multiple directional antenna arrays. Non-scanning transmitting means illuminating entire search space or subdivided sectors of space. Reflected signals simultaneously receiving from all object or multiple objects within all perimeter or each subdivided sector by set of directional antennas with overlap antenna patterns distributed in one axis, quadrature or multi-axis directions. Processing of received by directional antennas signals providing by multiple separate receiver chains coupled to each receiving antenna. Transmitting power and gain of receiver chains controlling separately in each subdivided sectors by automatic gain control circuit. Automatic gain control circuits allow to simultaneous detection of small range targets with high amplitude reflected targets and targets with small, reflected signals. All transmitting and receiving signals are synchronized by microwave or/and optical means directly in transceiver modules.

Monopulse systems can be continuous waves or pulsed [3].

In continuous wave radars with continuous object or multiple objects observation and integration of the received signals lead to increased object information and image resolution as result. Simultaneous correlation and integration of thousands of signals per second from each point of surveillance allows not only for the detection of low-level signals but can help recognize and classify objects by using diversity signals, polarization modulation, and intelligent processing. Non-scanning monopulse system allows dramatic decrease in transmitting power and at the same time increase in radar range by integrating 2-3 orders more signals than regular scanning radar systems.

Monopulse system can be passive, using ambient RF energy. Monopulse method provides better targets resolution of 2-3 orders then scanning radars. Synchronizing of signals directly in antennas provide high accuracy amplitude and phase measurement. Non scanning antenna array is phase/frequency independent and can be multi-frequency, multi-function. Antenna's communication interface and actuator interfaces are providing separate connection of each antenna with corresponding receiving chain.

Processor and actuator means can be arranged as microwave and/or optical interfaces. All receiving chains using ratio of amplitudes, phases and relative frequency components shift of signals for multi-axis signal processing. Multi-axis processed signals from receiving antennas are applied for detection and identification of targets in each separate set of receiving antennas and for generating alarm signal and multi-axis signals proportional target range, angle of arrival and speed.

Monopulse means can consist filters in identification circuits for separation clutter signals, target signals form background noise, moving targets, identification of moving targets. Integration time for receiving signals controlling depends on the detected target range and speed, where longer integrating time corresponding to the longer range.

### CONCLUSION

Cover of whole imaging object and continuous illumination of object providing by staring array of directional antennas increasing imaging resolution and probability of object recognition.

Multi-axis distribution of overlap antennas allows to receive maximum information about shape and content of imaging object.

Coupling of each directional antenna with separate receiver channel allows receive information about whole object simultaneously and much faster.

Monopulse processing of signals and receiving signals from reference sub-set of antennas with overlap antenna patterns provides highest directing accuracy and better clutter/noise and media influence suppression.

Separate controlling of transmitting power and gain of receiver chains in each subdivided sectors by automatic gain control circuit provides possibility to use proposed radar system in urban and mountains areas. Automatic gain control circuits also allow to simultaneous detection of small range objects with high amplitude reflected targets and targets with small, reflected signals.

Application of multiple directional antennas provides larger signal gain compere to phase arrays, where signal gain decreasing proportional to number of beams.

Distribution of directional antennas decrease radar vulnerability because each directional antenna/subarray covering one subdivided sector and cannot be damaged by EMP positioned outside of sector area because of application of directional antennas.

Digitizing and synchronization of all receiving signals by microwave or/and optical means directly on directional antennas allows loos distribution of antennas without complicate phase adjustment matrixes.

Directional antenna array does not need beam forming module. System has small weight, size, may be portable or mounted on light vehicle or small drone because small size and weight.

1. Fly eye imaging radar comprising at least one antenna array, means for transmitting radar signals, means for receiving radar signals and means for processing the radar signals wherein:
said antenna array arranged as array of directional antennas covering wide area of observation with staring, not scanning, overlap in as minimum one axis antenna patterns creating antenna sub-arrays in each axis;
means for transmitting radar signals comprising as minimum one phase-locked loop, signal generator and controllable power amplifier connected with transmitting antenna covering whole area or sub-sector of area of observation;
means for receiving radar signals comprising multiple separate receiving channels with signal conditioning circuit including voltage or current limiters, anti-aliasing circuits, Automatic Gain Control (AGC) means, directional coupler with signal detector and analog-to-digital converter;
each directional antenna covering whole area or sub-sector of area of observation and coupled with separate receiving cannel providing fast continuous parallel processing of signals for receiving maximum information from all covering area simultaneously;
means for processing the radar signals comprising multi-channel processor, image generator, memory for real time recording digital hologram, synchronization means and at least one monopulse processor connected to each antenna sub-array by directional coupler with signal detector for creating monopulse subarrays;
monopulse subarrays comprising means for one or multi-axis processing of all signals in receiving channels as ratio of amplitudes and/or phase shift of signals for direction finding and one-iteration adapting for clutter suppressing or decrease transferring media influence to receiving chain parameters by phase shift in subarray of neighboring directional antennas with overlap antenna patterns, wherein application of signals from reference antennas providing highest directional accuracy and better clutter/noise and media influence suppression;
said multi-channel processor comprised means for transform, correct and filter received signals from time domain to frequency domain and space one axis and/or multi-axis domain to increase image resolution and number of parameters for object recognition;
said antenna array, receiving and processing means arranged for receiving additional Doppler shifted and diffracted spectrum components consists of information about moving objects, objects content by spectrum signature and object shape;
said image generator arranged for generating one or multi-axis images in time, frequency, space or combined domains;
means for transmitting radar signals, means for receiving radar signals and means for processing the radar signals are connected by digital interface arranged as universal serial bus (USB) or microwave and/or fiber optic waveguides to signal processor or wireless.

2. Fly eye imaging radar of claim 1, wherein said antenna array coupled with transmitting and receiving means are arranged as concave, convex, cylindric full/hemi sphere modules consisting of plurality of antenna elements which forming directional antennas coupled with synchronized transmitting and receiving means which may be distributed around perimeter of carrier vehicle or between swarm of vehicles.

3. Fly eye imaging radar of claim 1, wherein said means for transmitting, receiving and processing means are arranged for simultaneous transmitting, receiving, and processing signals on a few different frequencies (multi-frequency signals) and different modes signals, such as communication, navigation, control (multi-mode, multi-function signals) and comprising corresponding arranged directional antennas, anti-aliasing circuits and filtering means in each transmitter and receiving chain.

4. Passive Fly eye imaging radar comprising at least one antenna array, means for receiving radar signals and means for processing the radar signals wherein:
said antenna array arranged as array of directional antennas covering wide area of observation with staring, not scanning, overlap in as minimum one axis antenna patterns creating antenna sub-arrays in each axis;
means for receiving radar signals comprising multiple separate receiving channels with signal conditioning circuit including voltage or current limiters, anti-aliasing circuits, Automatic Gain Control (AGC) means, directional coupler with signal detector and analog-to-digital converter;
each directional antenna covering whole area or sub-sector of area of observation and coupled with separate receiving cannel providing fast continuous parallel processing of signals for receiving maximum information from all targets simultaneously;
means for processing the radar signals comprising image generator, multi-channel processor, memory for real time recording digital hologram, synchronization means and at least one monopulse processor connected to each antenna sub-array by directional coupler with signal detector for creating monopulse subarrays;
monopulse subarrays comprising means for one or multi-axis processing of all signals in receiving channels as ratio of amplitudes and/or phase shift of signals for direction finding and one-iteration adapting for clutter suppressing or decrease transferring media influence to receiving chain parameters by phase shift in subarray of neighboring directional antennas with overlap antenna patterns, wherein application of signals from reference antennas providing highest directional accuracy and better clutter/noise and media influence suppression;
said multi-channel processor comprised means for transform, correct and filter received signals from time domain to frequency domain and space one axis and/or multi-axis domain to increase image resolution and number of parameters for object recognition;
said antenna array, receiving and processing means arranged for receiving additional Doppler shifted and diffracted spectrum components consists of information about moving objects, objects content by spectrum signature and object shape;
said image generator arranged for generating one or multi-axis images in time, frequency, space or combined domains;
means for receiving radar signals and means for processing the radar signals are connected by digital interface arranged as universal serial bus (USB) or microwave and/or fiber optic waveguides to signal processor or wireless.
